(19) United States
(12) Patent Application Publication
(10) Pub. No.: US 2026/0312128 A1
(43) Pub. Date: Oct. 8, 2026

(54) SOLID ELECTROLYTE, SOLID ELECTROLYTE LAYER, AND SOLID ELECTROLYTE BATTERY

(71) Applicant: TOHOKU UNIVERSITY, Miyagi (JP)

(72) Inventors: Saneyuki OHNO, Fukuoka (JP); Zheng HUANG, Fukuoka (JP)

(73) Assignee: TOHOKU UNIVERSITY, Miyagi (JP)

(21) Appl. No.: 19/484,153

(22) PCT Filed: May 17, 2024
(86) PCT No.: PCT/JP2024/018413

§ 371 Date: Nov. 13, 2025

(30) Foreign Application Priority Data
May 17, 2023 (JP) 2023-081319

(51) Int. Cl. H01M 10/0562; H01M 10/054

(52) U.S. Cl. CPC H01M 10/0562; H01M 10/054; H01M 2300/008

(57) ABSTRACT

The present invention is to provide a solid electrolyte having high sodium ion conductivity. A solid electrolyte containing a compound represented by Formula (1) or Formula (2):

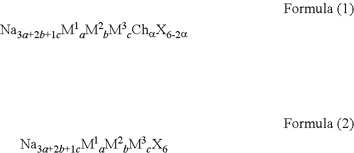

In Formulae (1) and (2), M¹ is selected from the group consisting of Y, Sc, Al, Ga, In, La, Ce, Pr, Nd, Pm, Sm, Eu, Gd, Tb, Dy, Ho, Er, Tm, Yb, Lu, and combinations thereof; M² is selected from the group consisting of Zr, Hf, Ti, Si, Ge, Sn, and combinations thereof; and M³ is selected from the group consisting of Nb, Ta, V, P, Sb, Bi, and combinations thereof. Ch is selected from the group consisting of O, S, Se, Te, and combinations thereof; and X is selected from the group consisting of F, Cl, Br, I, and combinations thereof.

### TECHNICAL FIELD

The present invention relates to a solid electrolyte, a solid electrolyte layer, and a solid electrolyte battery.

### BACKGROUND ART

In the related art, lithium ion secondary batteries have been mounted on a wide variety of electronic and electrical devices including mobile phones, notebook computers, digital cameras and videos, and portable music players. Batteries serving as the power source for electronic and electric devices are strongly required to be reduced in size and thickness and to be improved in safety. In the lithium ion secondary batteries widely used at present, charging and discharging are performed by lithium ions moving between a positive electrode and a negative electrode via an electrolytic solution, and an organic solvent is used as the electrolytic solution. Since a flammable organic solvent is used as the electrolytic solution, it is a problem to ensure the safety against liquid leakage or the like.

Therefore, an all-solid-state lithium ion secondary battery in which a solid electrolyte layer is provided between the positive electrode and the negative electrode has been developed. As the solid electrolyte, there has been oxide-based solid electrolytes, sulfide-based solid electrolytes, complex hydride-based solid electrolytes, and the like. In recent years, use of halide-based solid electrolytes as the solid electrolyte has also been studied (PTL 1 and PTL 2).

For example, PTL 1 discloses a solid electrolyte formed of a compound represented by the following Formula [1].

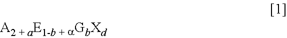

In Formula [1], A is one element selected from the group consisting of Li, K, and Na; E is at least one element selected from the group consisting of Zr, Hf, Ti, and Sn; G is at least one element selected from the group consisting of Mg, Ca, Sr, Cs, Ba, Y, Al, Sc, La, Ce, Pr, Nd, Pm, Sm, Eu, Gd, Tb, Dy, Ho, Er, Tm, Yb, Lu, Cu, Ag, Au, Pb, Bi, In, Sn, Sb, Nb, Ta, and W; and X is at least one selected from the group consisting of F, Cl, Br, and I. In PTL 1, the battery performance is evaluated only when A is Li.

PTL 2 discloses a solid electrolyte having a crystal of a structure represented by A_{4-2x-y-z}BₓSn_{3-y}M_{y}O_{8-z}N_{z} (1≤4−2x−y−z<4, A: Li, Na; B: Mg, Ca, Sr, Ba; M: V, Nb, Ta; and N: F, Cl).

Sodium is considered to have a larger resource amount than lithium, and has no risk of uneven distribution in the production area. Therefore, in recent years, it has been expected to put all-solid-state sodium ion batteries into practical use, instead of all-solid-state lithium ion batteries. In order to put all-solid-state sodium ion batteries into practical use, development of a solid electrolyte material exhibiting high sodium ion conductivity is required.

As the solid electrolyte conducting sodium ions, similar to the solid electrolyte material conducting lithium ions, there has been oxide-based solid electrolytes, sulfide-based solid electrolytes, and the like. In recent years, use of halide-based solid electrolytes as the solid electrolyte has also been studied. Oxide-based solid electrolytes are excellent in chemical and electrochemical stability, but require heat treatment at a high temperature to exhibit high ionic conductivity. On the other hand, sulfide-based solid electrolytes can exhibit high ionic conductivity only by compression molding, but have poor chemical and electrochemical stability. Therefore, there is an increasing expectation for a halide-based solid electrolyte that can be subjected to compression molding at room temperature and has higher electrochemical stability than sulfide-based solid electrolytes. For example, NPL 1 reports Na₃₋ₓY₁₋ₓZrₓCl₆ as a solid electrolyte for high-voltage and long-life all-solid-state sodium ion batteries.

### CITATION LIST

### Patent Literature

PTL 1: WO2021/024783
PTL 2: WO2014/141456

### Non Patent Literature

NPL 1: Nature Communications volume 12, Article number: 1256 (2021)

### SUMMARY OF INVENTION

### Technical Problem

As described above, a halide-based solid electrolyte for an all-solid-state sodium ion secondary battery has been reported, but the sodium ion conductivity thereof is not sufficient, and development of a halide-based solid electrolyte material exhibiting higher sodium ion conductivity is required.

Therefore, in order to solve such problems of the related art, the present inventors have conducted studies for the purpose of providing a solid electrolyte having high sodium ion conductivity.

### Solution to Problem

Specific embodiments of the present invention will be described below.
[1] A solid electrolyte containing a compound represented by Formula (1) or Formula (2):

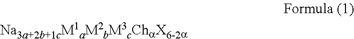

(in Formula (1), M¹ is selected from the group consisting of Y, Sc, Al, Ga, In, La, Ce, Pr, Nd, Pm, Sm, Eu, Gd, Tb, Dy, Ho, Er, Tm, Yb, Lu, and combinations thereof; M² is selected from the group consisting of Zr, Hf, Ti, Si, Ge, Sn, and combinations thereof; M³ is selected from the group consisting of Nb, Ta, V, P, Sb, Bi, and combinations thereof; Ch is selected from the group consisting of O, S, Se, Te, and combinations thereof; X is selected from the group consisting of F, Cl, Br, I, and combinations thereof; a+b+c=1, 0≤a≤1, 0≤b≤1, 0≤c≤1, and 0.1≤α≤2.9.)

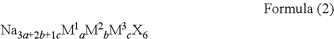

(in Formula (2), M¹ is selected from the group consisting of Y, Sc, Al, Ga, In, La, Ce, Pr, Nd, Pm, Sm, Eu, Gd, Tb, Dy, Ho, Er, Tm, Yb, Lu, and combinations thereof; M² is selected from the group consisting of Zr, Hf, Ti, Si, Ge, Sn, and combinations thereof; M³ is selected from the group consisting of Nb, Ta, V, P, Sb, Bi, and combinations thereof; X is selected from the group consisting of F, Cl, Br, I, and combinations thereof; and a+b+c=1, 0≤a≤0.9, 0≤b≤0.9, and 0.1≤c≤1.)
[2] The solid electrolyte according to [1], in which in Formula (2), M³ is selected from the group consisting of Ta and Nb.
[3] The solid electrolyte according to [1], in which in Formula (1), X is Cl.
[4] The solid electrolyte according to [1], in which in Formula (2), X is Cl.
[5] The solid electrolyte according to any one of [1] to [4], in which
the solid electrolyte has a sodium ion conductivity of 1×10⁻⁶ S/cm or more at 25° C. when subjected to compression molding at room temperature under a pressure of 170 MPa.
[6] The solid electrolyte according to any one of [1] to [5], having a relative density of 80% or more when subjected to compression molding at room temperature under a pressure of 170 MPa.
[7] A solid electrolyte containing a compound represented by Formula (1′):

The present embodiment may relate to a solid electrolyte containing a compound represented by Formula (1′).

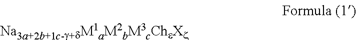

(in Formula (1′), M¹ is selected from the group consisting of Y, Sc, Al, Ga, In, La, Ce, Pr, Nd, Pm, Sm, Eu, Gd, Tb, Dy, Ho, Er, Tm, Yb, Lu, and combinations thereof; M² is selected from the group consisting of Zr, Hf, Ti, Si, Ge, Sn, and combinations thereof; M³ is selected from the group consisting of Nb, Ta, V, P, Sb, Bi, and combinations thereof; Ch is selected from the group consisting of O, S, Se, Te, and combinations thereof; X is selected from the group consisting of F, Cl, Br, I, and combinations thereof; a+b+c=1, 0≤a≤1, 0≤b≤1, 0≤c≤1, 0≤γ≤1, 0≤δ≤2, 0≤ε≤2, and 4≤ζ≤8.)
[8] The solid electrolyte according to [7], in which in Formula (1′), X is Cl.
[9] The solid electrolyte according to any one of [7] to [8], in which
the solid electrolyte has a sodium ion conductivity of 1×10⁻⁶ S/cm or more at 25° C. when subjected to compression molding at room temperature under a pressure of 170 MPa.
[10] The solid electrolyte according to any one of [7] to [9], having a relative density of 80% or more when subjected to compression molding at room temperature under a pressure of 170 MPa.
[11] A solid electrolyte layer containing the solid electrolyte according to any one of [1] to [10].
[12] A solid electrolyte battery containing the solid electrolyte layer according to [11].

### Advantageous Effects of Invention

The present invention can provide a solid electrolyte having high sodium ion conductivity. In addition, the present invention can provide a solid electrolyte layer and a solid electrolyte battery (all-solid-state sodium ion secondary battery) that exhibit high sodium ion conductivity.

### BRIEF DESCRIPTION OF DRAWINGS

FIG. 1 is an analysis result of energy X-ray diffraction of NaNbCl₆.

FIG. 2 is an analysis result of energy X-ray diffraction of NaTaCl₆.

FIG. 3 is an analysis result of energy X-ray diffraction of Na₃YCl₆.

FIG. 4 is an analysis result of energy X-ray diffraction of NaNbOCl₄.

FIG. 5 is an analysis result of energy X-ray diffraction of NaTaOCl₄.

FIG. 6 illustrates measurement results of sodium ion conductivity of solid electrolytes obtained in the examples and comparative examples.

FIG. 7 is an analysis result of energy X-ray diffraction of NaNbCl₆ after heat treatment.

FIG. 8 is an analysis result of energy X-ray diffraction of NaTaCl₆ after heat treatment.

FIG. 9 is an analysis result of energy X-ray diffraction of Na₃YCl₆ after heat treatment.

FIG. 10 illustrates measurement results of sodium ion conductivity before and after heat treatment of the solid electrolytes obtained in the examples and comparative examples.

FIG. 11 is an analysis result of energy X-ray diffraction of NaTaCl₆ in each temperature band.

FIG. 12 is a result of diffusion reflection measurement of NaNbCl₆.

FIG. 13 is a result of diffusion reflection measurement of NaTaCl₆.

FIG. 14 is a result of diffusion reflection measurement of NaTaOCl₄.

FIG. 15 is a result of diffusion reflection measurement of NaNbOCl₄.

FIG. 16 is a result of X-ray diffraction and impedance measurement of Na₁₊ₓTa₁₋ₓZrₓCl₆ (x<1.0).

FIG. 17 is a measurement result of sodium ion conductivity of Na₁₊ₓTa₁₋ₓZrₓCl₆ (x<1.0).

FIG. 18 is a result of X-ray diffraction and impedance measurement when NaTa_{1/5(3+2x)}OₓCl₄ was synthesized using Ta₂O₅ as an oxygen source.

FIG. 19 is a measurement result of sodium ion conductivity when NaTa_{1/5(3+2x)}O_{X}Cl₄ was synthesized using Ta₂O₅ as an oxygen source.

FIG. 20 is a result of X-ray diffraction and impedance measurement when Na₁₊ₓTaOCl₄₊ₓ was synthesized using Ta₂O₅ as an oxygen source.

FIG. 21 is a measurement result of sodium ion conductivity when Na₁₊ₓTaOCl₄₊ₓ was synthesized using Ta₂O₅ as an oxygen source.

FIG. 22 is a measurement result of sodium ion conductivity when NaTaOCl₄ was synthesized by using Ta₂O₅ as an oxygen source while changing the process time.

FIG. 23 is a measurement result of sodium ion conductivity when NaTaOCl₄ was synthesized by using Ta₂O₅ as an oxygen source while changing the process time.

FIG. 24 is a result of X-ray diffraction and impedance measurement when Na₂ₓTaOₓCl₅ was synthesized using Na₂O as an oxygen source.

FIG. 25 is a measurement result of sodium ion conductivity when Na₂ₓTaOₓCl₅ was synthesized using Na₂O as an oxygen source.

### DESCRIPTION OF EMBODIMENTS

Hereinafter, the present invention will be described in detail. The description of the constituent elements described below may be based on representative embodiments and specific examples, but the present invention is not limited to such embodiments. In the present specification, a numerical range expressed with “to” means a range that includes numerical values written before and after “to” as a lower limit value and an upper limit value.

### (Solid Electrolyte)

The present embodiment relates to a solid electrolyte containing a compound represented by Formula (1) or Formula (2):

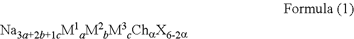

(in Formula (1), M¹ is selected from the group consisting of Y, Sc, Al, Ga, In, La, Ce, Pr, Nd, Pm, Sm, Eu, Gd, Tb, Dy, Ho, Er, Tm, Yb, Lu, and combinations thereof; M² is selected from the group consisting of Zr, Hf, Ti, Si, Ge, Sn, and combinations thereof; M³ is selected from the group consisting of Nb, Ta, V, P, Sb, Bi, and combinations thereof; Ch is selected from the group consisting of O, S, Se, Te, and combinations thereof; X is selected from the group consisting of F, Cl, Br, I, and combinations thereof; a+b+c=1, 0≤a≤1, 0≤b≤1, 0≤c≤1, and 0.1≤α≤2.9.)

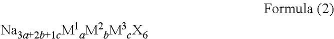

(in Formula (2), M¹ is selected from the group consisting of Y, Sc, Al, Ga, In, La, Ce, Pr, Nd, Pm, Sm, Eu, Gd, Tb, Dy, Ho, Er, Tm, Yb, Lu, and combinations thereof; M² is selected from the group consisting of Zr, Hf, Ti, Si, Ge, Sn, and combinations thereof; M³ is selected from the group consisting of Nb, Ta, V, P, Sb, Bi, and combinations thereof; X is selected from the group consisting of F, Cl, Br, I, and combinations thereof; and a+b+c=1, 0≤a≤0.9, 0≤b≤0.9, and 0.1≤c≤1.)

In Formula (1), M¹ is selected from the group consisting of Y, Sc, Al, Ga, In, La, Ce, Pr, Nd, Pm, Sm, Eu, Gd, Tb, Dy, Ho, Er, Tm, Yb, Lu, and combinations thereof. Among these, M¹ is preferably one selected from the group consisting of Y, Sc, Al, Ga, In, La, Ce, Pr, Nd, Pm, Sm, Eu, Gd, Tb, Dy, Ho, Er, Tm, Yb, and Lu, and more preferably one selected from the group consisting of Y, Sc, and In. In the case of a combination of elements in M¹, for example, a solid solution of two or more of the above elements may be used.

In Formula (1), 0≤a≤1, preferably 0≤a≤0.9, more preferably 0≤a≤0.7, and still more preferably 0≤a≤0.5. In Formula (1), a=0 is also preferable, and M¹ is not contained if a is 0.

In Formula (1), M² is selected from the group consisting of Zr, Hf, Ti, Si, Ge, Sn, and combinations thereof. Among these, M² is preferably one selected from the group consisting of Zr, Hf, Ti, Si, Ge, and Sn, and more preferably one selected from the group consisting of Zr and Hf.

In Formula (1), 0≤b≤1, preferably 0≤b≤0.9, more preferably 0≤b≤0.7, and still more preferably 0≤b≤0.5. In Formula (1), b=0 is also preferable, and M² is not contained if b is 0.

In Formula (1), M³ is selected from the group consisting of Nb, Ta, V, P, Sb, Bi, and combinations thereof. Among these, M³ is preferably one selected from the group consisting of Nb, Ta, V, P, Sb, and Bi, more preferably one selected from the group consisting of Nb, Ta, and V, and particularly preferably Nb or Ta.

In Formula (1), 0≤c≤1, preferably 0.1≤c≤1, and more preferably 0.2≤c≤1. In Formula (1), a+b+c=1.

In Formula (1), Ch is selected from the group consisting of O, S, Se, Te, and combinations thereof. Among these, Ch is preferably one selected from the group consisting of O, S, Se, and Te, more preferably O or S, and particularly preferably 0. By introducing an element selected from the group consisting of O, S, Se, Te, and combinations thereof into Ch as in the compound represented by Formula (1), the conductivity of the solid electrolyte can be more effectively improved.

In Formula (1), X is selected from the group consisting of F, Cl, Br, I, and combinations thereof. Among these, X is preferably one selected from the group consisting of F, Cl, Br, and I, more preferably Cl or Br, and particularly preferably Cl. If Ch described above in Formula (1) is 0, the compound represented by Formula (1) is an acid halogen-based compound. The present embodiment preferably uses an acid halogen-based compound, which is capable of exhibiting high sodium ion conductivity.

In Formula (1), 0.1≤α≤2.9, preferably 0.2≤α≤2.0, and more preferably 0.5≤α≤1.5. Among these, a is particularly preferably 1.

The present embodiment may relate to a solid electrolyte containing a compound represented by Formula (1′).

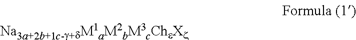

(in Formula (1′), M¹ is selected from the group consisting of Y, Sc, Al, Ga, In, La, Ce, Pr, Nd, Pm, Sm, Eu, Gd, Tb, Dy, Ho, Er, Tm, Yb, Lu, and combinations thereof; M² is selected from the group consisting of Zr, Hf, Ti, Si, Ge, Sn, and combinations thereof; M³ is selected from the group consisting of Nb, Ta, V, P, Sb, Bi, and combinations thereof; Ch is selected from the group consisting of O, S, Se, Te, and combinations thereof; X is selected from the group consisting of F, Cl, Br, I, and combinations thereof; a+b+c=1, 0≤a≤1, 0≤b≤1, 0≤c≤1, 0≤γ<≤1, 0≤δ≤2, 0≤ε≤2, and 4≤ζ≤8.)

Examples and preferred ranges of M¹, M², M³, Ch, and X in Formula (1′) are the same as those of M¹, M², M³, Ch, and X in Formula (1). The preferable numerical ranges of a, b, and c in Formula (1′) are the same as the preferable numerical ranges of a, b, and c in Formula (1). Y is preferably 0.2 or less, and more preferably 0. (−γ+δ) is preferably 0 or more and 2 or less. (3a+2b+1c−γ+δ) is preferably 1 or more and 3 or less. ε is preferably 0.3 or more and 1 or less. ε is preferably 4 or more and 7 or less, and more preferably 4 or more and 6 or less.

The compound represented by Formula (1) is preferably a compound represented by the following Formula (11).

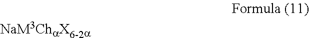

(In Formula (11), M³ is selected from the group consisting of Nb, Ta, V, P, Sb, Bi, and combinations thereof; Ch is selected from the group consisting of O, S, Se, Te, and combinations thereof; X is selected from the group consisting of F, Cl, Br, I, and combinations thereof; and 0.1≤α≤2.9.)

Examples and preferred ranges of M³, Ch and X in Formula (11) are the same as those of M³, Ch, and X in Formula (1).

When the compound represented by Formula (1) is subjected to diffusion reflection measurement, the value of the band gap obtained from the absorption coefficient obtained by converting the measured data by the Kubelka-Munk function is preferably 2 eV or more, more preferably 2.5 eV or more, and still more preferably 3 eV or more. By setting the value of the band gap within the above range, the compound represented by Formula (1) can exhibit high electronic insulation.

In Formula (2), M¹ is selected from the group consisting of Y, Sc, Al, Ga, In, La, Ce, Pr, Nd, Pm, Sm, Eu, Gd, Tb, Dy, Ho, Er, Tm, Yb, Lu, and combinations thereof. Among these, M¹ is preferably one selected from the group consisting of Sc, Al, Ga, In, La, Ce, Pr, Nd, Pm, Sm, Eu, Gd, Tb, Dy, Ho, Er, Tm, Yb, and Lu, and more preferably one selected from the group consisting of Y, Sc, and In.

In Formula (2), 0≤a≤0.9, preferably 0≤a≤0.8, more preferably 0≤a≤0.7, and still more preferably 0≤a≤0.5. In Formula (2), a=0 is also preferable, and M¹ is not contained if a is 0.

In Formula (2), M² is selected from the group consisting of Zr, Hf, Ti, Si, Ge, Sn, and combinations thereof. Among these, M² is preferably one selected from the group consisting of Zr, Hf, Ti, Si, Ge, and Sn, and more preferably one selected from the group consisting of Zr and Hf. It is also preferable that M² is Si or Ge.

In Formula (2), 0≤b≤0.9, preferably 0≤b≤0.8, more preferably 0≤b≤0.7, and still more preferably 0≤b≤0.5. In Formula (2), b=0 is also preferable, and M² is not contained if b is 0.

In Formula (2), M³ is selected from the group consisting of Nb, Ta, V, P, Sb, Bi, and combinations thereof. Among these, M³ is preferably one selected from the group consisting of Nb, Ta, V, P, Sb, and Bi, more preferably one selected from the group consisting of Nb, Ta, and V, and particularly preferably Nb or Ta.

In Formula (2), 0≤c≤1, preferably 0.1≤c≤1, and more preferably 0.2≤c≤1. In Formula (2), a+b+c=1.

In Formula (2), X is selected from the group consisting of F, Cl, Br, I, and combinations thereof. Among these, X is preferably one selected from the group consisting of F, Cl, Br, and I, preferably Cl or Br, and particularly preferably Cl.

The compound represented by Formula (2) is preferably a compound represented by the following Formula (12).

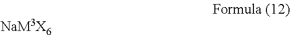

(In Formula (12), M³ is selected from the group consisting of Nb, Ta, V, P, Sb, Bi, and combinations thereof; and X is selected from the group consisting of F, Cl, Br, I, and combinations thereof.)

Examples and preferred ranges of M³ and X in Formula (12) are the same as those of M³ and X in Formula (2)

When the compound represented by Formula (2) is subjected to diffusion reflection measurement, the value of the band gap obtained from the absorption coefficient obtained by converting the measured data by the Kubelka-Munk function is preferably 2 eV or more, more preferably 2.5 eV or more, and still more preferably 3 eV or more. By setting the value of the band gap within the above range, the compound represented by Formula (2) can exhibit high electronic insulation.

In the compounds represented by Formula (1) and Formula (2), it is preferable that a metal element and a halogen element form an octahedron by six-coordination, and the octahedron serves as the basic structure of the anion sublattice. A compound having a glassy or deficient double perovskite structure is more preferable. The compounds represented by Formula (1) and Formula (2) are novel compounds as solid electrolytes, and are halide-based solid electrolytes that exhibit high sodium ion conductivity.

The present embodiment has the above configuration, and thus has high sodium ion conductivity. For example, when the solid electrolyte is subjected to compression molding at room temperature and under a pressure of 170 MPa, the sodium ion conductivity at 25° C. is preferably 1×10⁻⁶ S/cm or more, more preferably 5×10⁻⁶ S/cm or more, still more preferably 1×10⁻⁵ S/cm or more, and particularly preferably 1×10⁻⁴ S/cm or more. As described above, since the solid electrolyte of the present embodiment has high sodium ion conductivity, a solid electrolyte battery including a solid electrolyte layer formed of the solid electrolyte material can exhibit excellent battery performance.

In the present specification, the sodium ion conductivity of the solid electrolyte is measured after the solid electrolyte is subjected to compression molding under a pressure of 170 MPa at room temperature. Since the solid electrolyte of the present embodiment can exhibit high sodium ion conductivity by compression molding at room temperature, the input of energy during use can be reduced.

The solid electrolyte of the present embodiment has the above-described configuration, and thus can exhibit high conductivity in a wide temperature range. For example, the solid electrolyte of the present embodiment can exhibit high conductivity even in a relatively high temperature range (for example, about 50° C. to 600° C.), and can prevent a decrease in sodium ion conductivity even in that case.

Further, even when the solid electrolyte of the present embodiment is subjected to heat treatment, a decrease in sodium ion conductivity is prevented. For example, even when the solid electrolyte of the present embodiment is subjected to heat treatment at 200° C. for 12 hours, the conductivity hardly decreases, and high sodium ion conductivity is maintained. Therefore, when the solid electrolyte of the present embodiment is used, the interface state can be adjusted by heat treatment.

The solid electrolyte of the present embodiment has high moldability. The solid electrolyte of the present embodiment has a high relative density even when subjected to compression molding. Specifically, when the solid electrolyte is subjected to compression molding at room temperature under a pressure of 170 MPa, the relative density is preferably 80% or more. The relative density is a relative density to the theoretical density, and a value theoretically obtained from the crystal structure is used as the theoretical density.

In the solid electrolyte of the present embodiment, for example, by containing Ta or Nb, electrostatic repulsion between cations in the structure is enhanced, and a structure in which octahedrons share vertices can be exhibited. As a result, an increase in free volume necessary for sodium ion conduction is expected (Pauling's third rule). Accordingly, it is considered that high sodium ion conductivity is exhibited. In addition, it is presumed that when an element having a larger valence as represented by M³ is contained, vacancies of sodium sites formed by using structural cations are generated. The formation energy phenomenon of sodium vacancies leads to a decrease in activation energy of sodium ion conduction. Among these, in the compound represented by Formula (1), by introducing an element such as oxygen into a skeleton of a structure constructed by a halogen, a vertex-sharing structure between octahedrons as the basic block of the structure is stabilized, which can construct a structure capable of securing a larger free volume and is assumed to contribute to improvement of conduction of sodium ions. In addition, when the structure is distorted by introducing a different type of anions into the structure and the energy of the Na sites is dispersed, it is considered that a percolation network of the Na sites in which the energy of the sites is close can be constructed with smaller activation energy. In particular, if the solid electrolyte contains Nb, Ta, or the like, a greatly deficient double perovskite structure is formed. Therefore, it is considered that a sodium ion conduction path can be secured even in a thermodynamically stable phase in which the sodium ion conductivity is considered to decrease in the related art. This is presumed to achieve a halogen-based solid electrolyte whose sodium ion conductivity does not decrease even after heat treatment.

The solid electrolyte of the present embodiment may contain one kind of compound having a single composition, or may contain two or more kinds of compounds having different compositions. The shape of the solid electrolyte is not particularly limited, and may be, for example, powders, particles, or lumps, and the solid electrolyte may be pellets or plates.

### (Method for Producing Solid Electrolyte)

If the solid electrolyte of the present embodiment is in powders, the solid electrolyte can be produced, for example, by mixing materials containing predetermined elements at a predetermined molar ratio. An acid hydride may be used as the material, although it is necessary to pay attention to the generation of HCl gas.

The solid electrolyte can be produced by, for example, a mechanochemical method. In order to cause the mechanochemical reaction, for example, a planetary ball mill apparatus is used. The planetary ball mill apparatus is an apparatus in which a sealed container is input a medium (balls for promoting pulverization or mechanochemical reaction) and the materials, and rotates and revolves to apply kinetic energy to the material to cause pulverization or mechanochemical reaction. In the planetary ball mill apparatus, for example, a sealed container made of zirconia and a medium (balls) made of zirconia can be used. By reacting the materials using the planetary ball mill apparatus, the materials during the reaction are less likely to reach a high temperature, and thus are less likely to cause phase separation. The method for producing solid electrolyte of the present embodiment can also be applied to production of a thermodynamically metastable phase. In addition, since the propagation of energy due to the impact of the medium contributes to the generation and continuance of defects, the method for producing solid electrolyte of the present embodiment can also be used to produce a solid electrolyte having a structure containing a large amount of defects or a glass phase.

Synthesis of solid electrolytes using the mechanochemical method is necessary for vitrification of substances, and tends to have an improved conductivity as the reaction time is longer. For example, when the materials are reacted using a planetary ball mill apparatus, the reaction time is preferably 5 hours to 200 hours, more preferably 10 hours to 150 hours, and still more preferably 25 hours to 100 hours.

The solid electrolyte may be produced by firing. The firing temperature is, for example, 150° C. to 600° C., and the firing time is preferably 10 minutes to 48 hours. The firing is preferably performed in vacuum or in an inert atmosphere.

The solid electrolyte may be produced by liquid phase synthesis. For example, the solid electrolyte can be synthesized in a predetermined organic solvent or aqueous solvent.

### (Solid Electrolyte Layer)

The present embodiment relates to a solid electrolyte layer including the above-described solid electrolyte. The solid electrolyte layer contains the above-described solid electrolyte in an amount of preferably 50% by mass or more, more preferably 60% by mass or more, still more preferably 70% by mass or more, still more preferably 80% by mass or more, and particularly preferably 90% by mass or more. The solid electrolyte layer may contain 100 mass % of the above-described solid electrolyte, and may be a layer formed of only the above-described solid electrolyte.

The sodium ion conductivity of the solid electrolyte layer at 25° C. is preferably 1×10⁻⁶ S/cm or more, more preferably 5×10⁻⁶ S/cm or more, still more preferably 1×10⁻⁵ S/cm or more, and particularly preferably 1×10⁻⁴ S/cm or more.

The relative density of the solid electrolyte layer is preferably 80% or more. The relative density is a relative density to the theoretical density, and a value theoretically obtained from the crystal structure is used as the theoretical density.

The thickness of the solid electrolyte layer is preferably 1 μm or more, more preferably 5 μm or more, and still more preferably 10 μm or more. The thickness of the solid electrolyte layer is preferably 1 mm or less. By setting the thickness of the solid electrolyte layer within the above range, the sodium ion conductivity can be increased more effectively.

The solid electrolyte layer may contain optional components other than the solid electrolyte described above without departing from the gist of the present invention. Examples of the optional component include a binder resin. In this case, the content of the optional component is preferably 10% by mass or less and more preferably 1% by mass or less relative to the total mass of the solid electrolyte.

### (Method for Producing Solid Electrolyte Layer)

The solid electrolyte layer is obtained by compressing and molding the obtained powdery solid electrolyte. In this case, for example, the molded body may be compressed at room temperature, or the molded body may be compressed using by hot pressing.

The solid electrolyte layer of the present embodiment can be obtained by compression molding at room temperature. The molding pressure at this time is preferably 50 MPa to 500 MPa. By subjecting the solid electrolyte layer of the present embodiment to compression molding at room temperature, the energy consumption during production can be limited, and a load on the environment can also be reduced.

The solid electrolyte layer may be a sintered body obtained by sintering the obtained powdery solid electrolyte. When the solid electrolyte layer is formed by sintering, the sintering temperature is preferably about 200° C. to 500° C., and the sintering time is preferably about 5 minutes to 60 minutes.

### (Solid Electrolyte Battery)

The present embodiment relates to a solid electrolyte battery including the above-described solid electrolyte layer. The solid electrolyte battery in the present embodiment is an all-solid-state sodium ion secondary battery.

The solid electrolyte battery is preferably an all-solid-state sodium ion secondary battery including a positive electrode, a solid electrolyte layer, and a negative electrode. In the present embodiment, a solid electrolyte layer is provided between the positive electrode and the negative electrode. In the all-solid-state sodium ion secondary battery, the positive electrode current collector may be laminated on the positive electrode, and the negative electrode current collector may be laminated on the negative electrode. Further, the all-solid-state sodium ion secondary battery may be housed in a battery case.

### <Positive Electrode>

The positive electrode includes a positive electrode active material. The positive electrode active material is preferably a compound capable of storing and releasing sodium. Examples of the positive electrode active material include a composite compound containing sodium and a transition metal, such as a composite oxide and a phosphate compound. Examples of the composite compound include a composite oxide containing sodium and a transition metal, and a phosphate compound containing sodium and a transition metal. Examples thereof include transition metal oxides such as Na₂Fe₂ (SO₄)₃, NaNi_{0.5}Mn_{0.5}O₂, NaFe_{0.5}Mn_{0.5}O₂, and NaFe_{0.5}Co_{0.5}O₂, and phosphoric acid-based positive electrodes such as Na₃V₂(PO₄)₃.

The positive electrode is also preferably a composite positive electrode. In this case, formed is a composite positive electrode including the above-described positive electrode active material and the above-described solid electrolyte. In the composite positive electrode, a positive electrode layer in which the positive electrode active material and the solid electrolyte are substantially uniformly mixed may be formed, and a layer containing the positive electrode active material as a main component may be laminated on the layer in which the positive electrode active material and the solid electrolyte are substantially uniformly mixed.

The positive electrode may contain an optional component in addition to the above-described active material. Examples of the optional component include a conductive aid and glass. In this case, the content of the optional component is preferably 20 vol % or less, and more preferably 5 vol % or less relative to the total volume of the positive electrode.

### <Negative Electrode>

The negative electrode contains a negative electrode active material. Examples of the negative electrode active material include a compound capable of storing and releasing sodium. Examples thereof include: inorganic compounds such as sodium metal, sodium alloys (alloys of sodium and metals such as tin, aluminum, and antimony), and tin compounds; carbon materials; silicon-based materials (Si, SiO); and conductive polymers.

The negative electrode may contain an optional component in addition to the above-described active material. Examples of the optional component include a binder resin and a negative electrode conductive agent. In this case, the content of the optional component is preferably 10 vol % or less, and more preferably 1 vol % or less relative to the total volume of the negative electrode.

The negative electrode is also preferably a composite negative electrode. In this case, formed is a composite negative electrode including the above-described negative electrode active material and solid electrolyte. In the composite negative electrode, a negative electrode layer in which the negative electrode active material and the solid electrolyte are substantially uniformly mixed may be formed, and a layer containing the negative electrode active material as a main component may be laminated on the layer in which the negative electrode active material and the solid electrolyte are substantially uniformly mixed.

### <Positive Electrode Current Collector>

The all-solid-state sodium ion secondary battery may have a positive electrode current collector above the positive electrode. The positive electrode current collector is electrically connected to the positive electrode. Examples of the constituent material of the positive electrode current collector include aluminum, stainless steel, and titanium. Examples of the form of the positive electrode current collector include a metal plate, a metal foil, a foamed metal plate, and an expanded metal.

### <Negative Electrode Current Collector>

The all-solid-state sodium ion secondary battery may have a negative electrode current collector above the negative electrode. The negative electrode current collector is electrically connected to the negative electrode. Examples of the constituent material of the negative electrode current collector include copper, stainless steel, titanium, and nickel. Examples of the form of the negative electrode current collector include a metal plate, a metal foil, a foamed metal plate, and an expanded metal.

### <Battery Case>

The battery case houses the laminate of the above-described positive electrode current collector, positive electrode, solid electrolyte layer, negative electrode, and negative electrode current collector. The shape of the battery case is not particularly limited, and can be appropriately selected according to various applications. Examples of the shape of the battery case include a cylindrical shape, a flat oval shape, a flat elliptical shape, and a rectangular shape. Examples of the constituent material of the battery case include aluminum, stainless steel, nickel-plated steel, and various resins.

### EXAMPLES

Hereinafter, the features of the present invention will be described more specifically with reference to the examples and comparative examples. The materials, use amounts, ratios, treatment contents, treatment procedures, and the like as shown in the following examples can be appropriately changed without departing from the gist of the present invention. Therefore, the scope of the present invention should not be construed as being limited to the following specific examples.

### Example 1: Preparation of NaNbCl₆

NaNbCl₆ was synthesized by a mechanochemical method using NaCl and NbCl₅ reagents. Specifically, the powdery reagents weighed at a stoichiometric ratio were filled together with a Zr milling medium into an 80 mL planetary ball mill cup made of zirconia, and subjected to mechanochemical synthesis at 500 rpm for 33 hours using a planetary ball mill P-7 manufactured by Fritsch. At this time, 10 minutes of mechanical mixing was repeated 198 times every 10 minutes to prevent the inside of the ball mill from being excessively heated. The obtained powder (solid electrolyte) was collected in a glove box, and its properties were studied by X-ray diffraction and impedance measurement.

### (Example 2: Preparation of NaTaCl₆)

NaTaCl₆ was synthesized by a mechanochemical method using NaCl and TaCl₅ reagents. Specifically, the powdery reagents weighed at a stoichiometric ratio were filled together with a Zr milling medium into an 80 mL planetary ball mill cup made of zirconia, and subjected to mechanochemical synthesis at 500 rpm for 33 hours using a planetary ball mill P-7 manufactured by Fritsch. At this time, 10 minutes of mechanical mixing was repeated 198 times every 10 minutes to prevent the inside of the ball mill from being excessively heated. The obtained powder was collected in a glove box, and its properties were studied by X-ray diffraction and impedance measurement.

### Example 3: Preparation of NaTaOCl₄

NaTaOCl₄ was synthesized by a mechanochemical method using NaCl, TaCl₅, and Ta₂O₅ reagents. Specifically, the powdery reagents weighed at a stoichiometric ratio were filled together with a Zr milling medium into an 80 mL planetary ball mill cup made of zirconia, and subjected to mechanochemical synthesis at 500 rpm for 80 hours using a planetary ball mill P-7 manufactured by Fritsch. At this time, 10 minutes of mechanical mixing was repeated 480 times every 10 minutes to prevent the inside of the ball mill from being excessively heated. The obtained powder was collected in a glove box, and its properties were studied by X-ray diffraction and impedance measurement.

### Example 4: Preparation of NaNbOCl₄

NaTaOCl₄ was synthesized by a mechanochemical method using NaCl, TaCl₅, and Nb₂O₅ reagents. Specifically, the powdery reagents weighed at a stoichiometric ratio were filled together with a Zr milling medium into an 80 mL planetary ball mill cup made of zirconia, and subjected to mechanochemical synthesis at 500 rpm for 80 hours using a planetary ball mill P-7 manufactured by Fritsch. At this time, 10 minutes of mechanical mixing was repeated 480 times every 10 minutes to prevent the inside of the ball mill from being excessively heated. The obtained powder was collected in a glove box, and its properties were studied by X-ray diffraction and impedance measurement.

### Comparative Example 1: Preparation of Na₃YCl₆

As a comparative example, Na₃YCl₆ was synthesized by a mechanochemical method using NaCl and YCl₅ reagents. Specifically, powdery reagents weighed at a stoichiometric ratio were filled together with a Zr milling medium into an 80 Ml planetary ball mill cup made of zirconia, and subjected to mechanochemical synthesis at 500 rpm for 33 hours using a planetary ball mill P-7 manufactured by Fritsch. At this time, 10 minutes of mechanical mixing was repeated 198 times every 10 minutes to prevent the inside of the ball mill from being excessively heated. The obtained powder was collected in a glove box, and its properties were studied by X-ray diffraction and impedance measurement.

### Measurement and Evaluation

### <Confirmation of Crystallization>

The solid electrolytes obtained in the examples and comparative examples were subjected to X-ray diffraction using a holder that allows measurement of the sample without exposure. Specifically, energy X-ray diffraction (XRD) analysis was performed using a device named Brucker D8 advanced. An XRD pattern in which 28 was 12 to 75 (degrees) was shown.

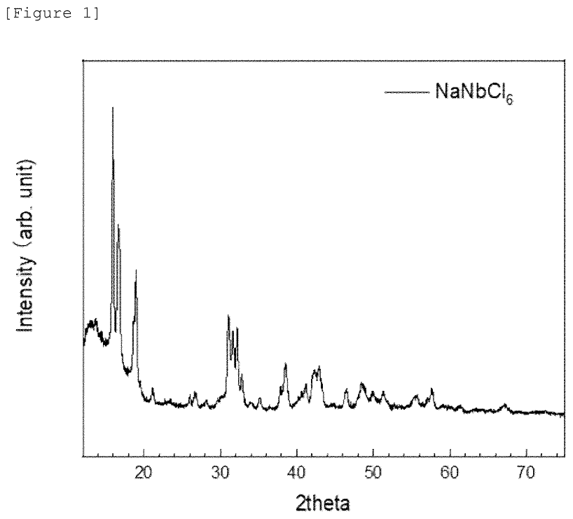

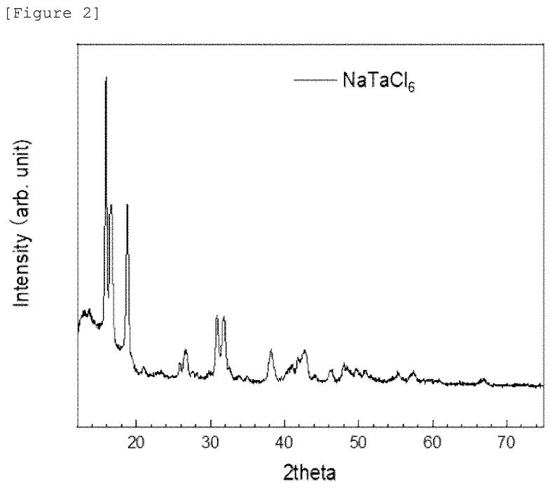

NaNbCl₆ has unique peaks at 15.9, 16.7, 18.9, and 31.1. In NaTaCl₆, almost the same pattern as that of NaNbCl₆ was observed, but each peak appeared at a low angle of about 0.1 to 0.5 due to the size effect of the crystal lattice (FIGS. 1 and 2).

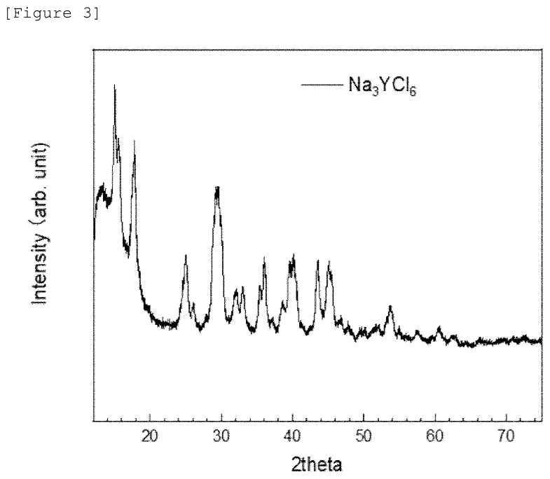

Na₃YCl₆ synthesized as a comparative example exhibited a pattern having a space group of P2₁/c, which is a previously reported crystal structure pattern (FIG. 3).

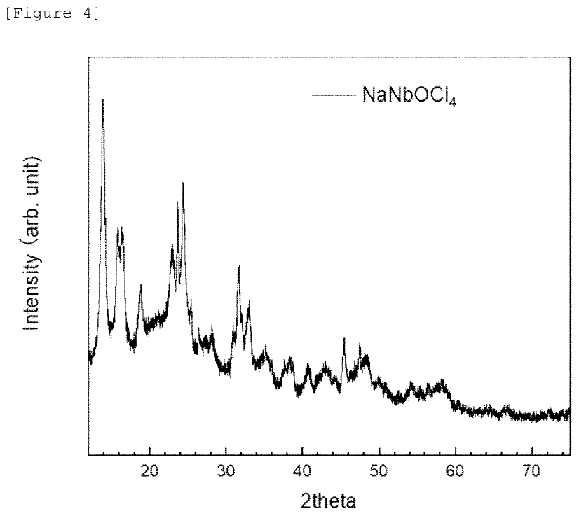

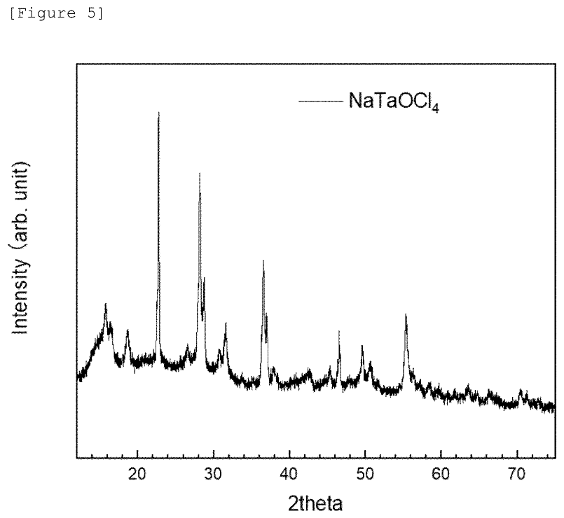

It was confirmed that the introduction of oxygen changed the crystal structure. In NaNbOCl₄, peaks particularly characterized by 13.9 and 16.3 were exhibited in addition to the small peaks that can be attributed to NaNbCl₆ (FIG. 4). On the other hand, a glassy pattern of NaTaOCl₄ was obtained except for the minute peaks that can be attributed to NaTaCl₆ and Ta₂O₅(FIG. 5)

### <Ionic Conductivity (1)>

Prepared was a press cell capable of performing electrochemical measurement while applying pressure to a sample without exposure. The solid electrolytes obtained in the examples and comparative examples were sealed therein and molded at a pressure of 170 MPa. SUS rods were used as electrodes to perform temperature-dependent AC impedance measurement using a VMP3 impedance analyzer manufactured by BioLogic. The resistance value at each temperature was obtained by fitting the obtained frequency response data using the software Relaxis3 and using an equivalent circuit. The ionic conductivity thereof was obtained from the resistance value and the cell constant of the sample, and the activation energy thereof was obtained from the temperature dependency.

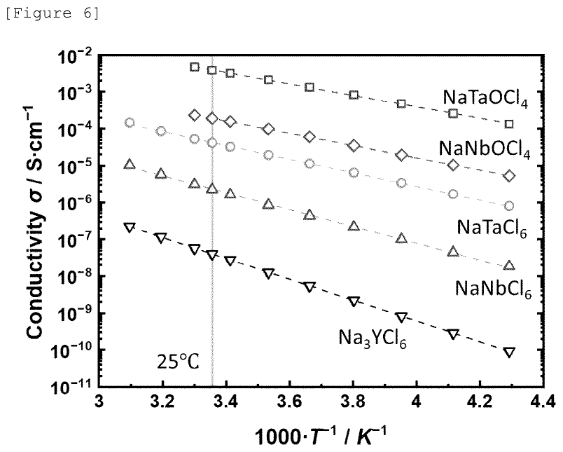

The conductivity of the solid electrolytes obtained in the examples was significantly improved as compared with the conductivity of the solid electrolytes obtained in the comparative examples. In Na₃YCl₆ of Comparative Example 1, it was confirmed that the conductivity was improved by reducing the amount of Na in the structure, but in the system of the examples in which the amount of Na was already small and high ionic conduction was exhibited due to high mobility, the conductivity was improved by increasing the amount of Na. Further, by introducing the oxygen group into the sample, a dramatic improvement in conductivity was observed in both the samples using Nb and Ta. In particular, in NaTaOCl₄ which uses Ta, conductivity comparable to that of a sulfide was achieved without the sulfur element (FIG. 6).

### <Ionic Conductivity (2)>

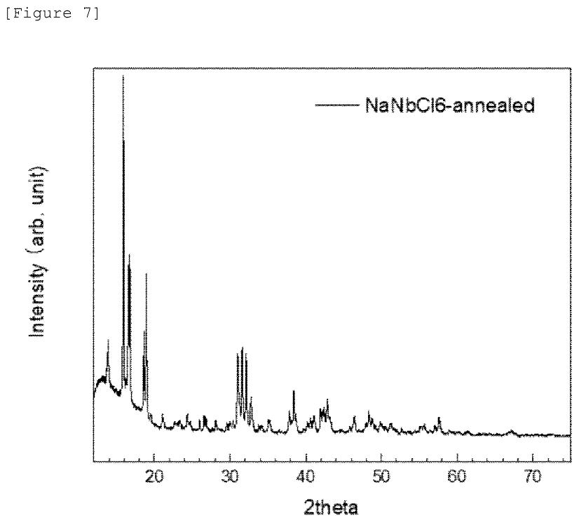

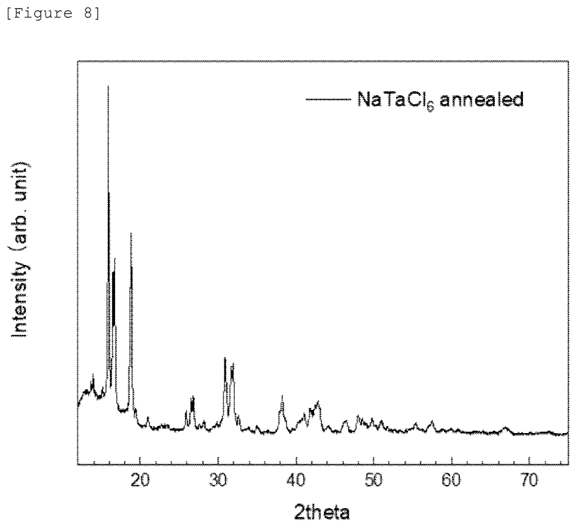

The change in structure and transportation of the solid electrolyte due to sintering were examined. As illustrated in FIGS. 7 to 9, it was found that the intensity of the peak was increased and the crystallinity was improved in the samples having a crystal structure due to annealing.

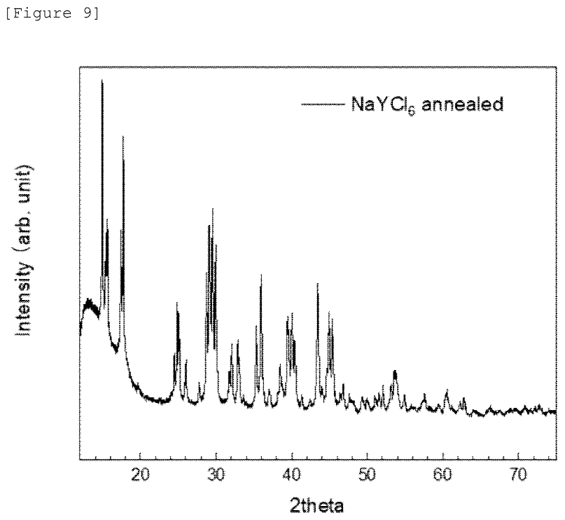

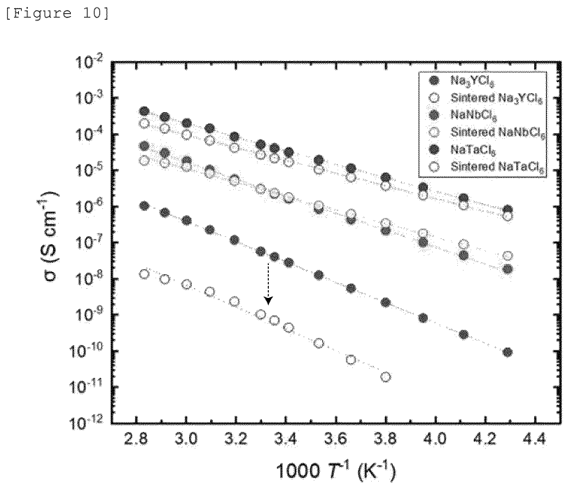

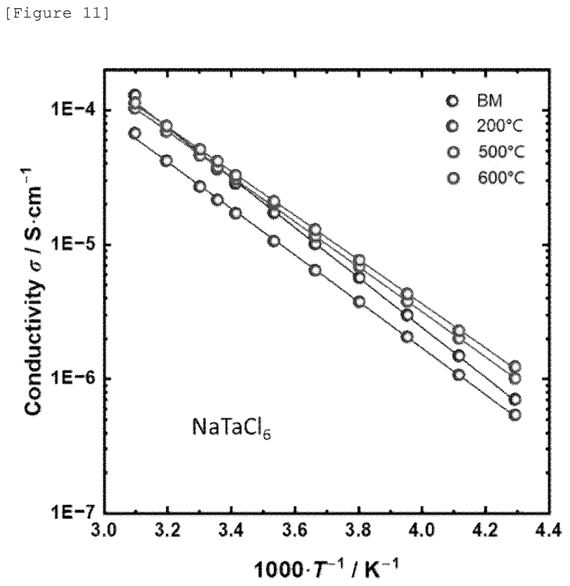

The open symbols in FIG. 10 indicate the conductivity of the samples after heat treatment at 200° C. for 12 hours. All the samples were pelletized and vacuum-sealed in a quartz tube, and all the operations were performed in a glove box filled with an inert gas. After the heat treatment, the sample was again powderized and placed in the above-described press cell for electrochemical measurement, and the conductivity thereof was measured. In Na₃YCl₆ of Comparative Example 1, the conductivity significantly decreased after the heat treatment (sintering) (the dotted arrows in FIG. 10), whereas in the samples containing Ta and Nb of the examples, the decrease in conductivity due to the heat treatment (sintering) was significantly limited. In addition, in NaTaCl₆, high conductivity was observed even if the heat treatment was performed in a wide temperature range (200° C., 500° C., or 600° C.) (FIG. 11). This suggested that the samples containing Ta and Nb maintained high conductivity in a wide temperature range, and the interface state could be adjusted by heat treatment.

### <Calculation of Relative Density (Relative to Theoretical Density)>

The relative density was calculated using the dimensional density relative to the theoretical density. 2 mg to 300 mg of the sample was sealed in the cell for electrochemical measurement, and was subjected to compression formation by applying a pressure of 170 MPa. The dimensional density was calculated from the surface area and thickness of the pellets after compression and the weight of the sample. As the theoretical density, a value theoretically obtained from the crystal structure was used. The relative density relative to the theoretical density was 80% to 90% in each composition before and after the heat treatment.

### <Calculation of Band Gap Value>

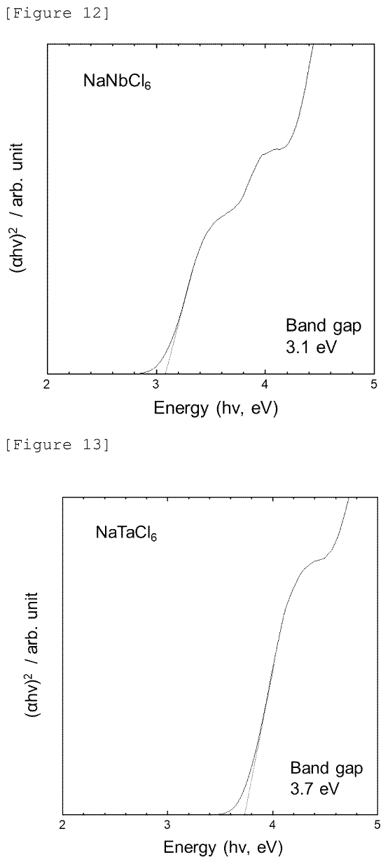

In order to examine the electronic characteristics of the solid electrolytes obtained in Examples 1 to 4, the size of the band gap was measured by diffusion reflection measurement using an ultraviolet-visible spectrometer. Powder of the solid electrolyte was used as a sample, and UV-3600 Plus manufactured by Shimadzu Corporation was used as an apparatus. In order to perform measurement without exposure to the atmosphere, the solid electrolyte powder was placed on a sample holder with a window in a glove box, and the window was sealed with vacuum grease to perform measurement. The measurement was performed at room temperature. The band gap value was obtained from an absorption coefficient obtained by converting measurement data by the Kubelka-Munk function (FIGS. 12 to 15).

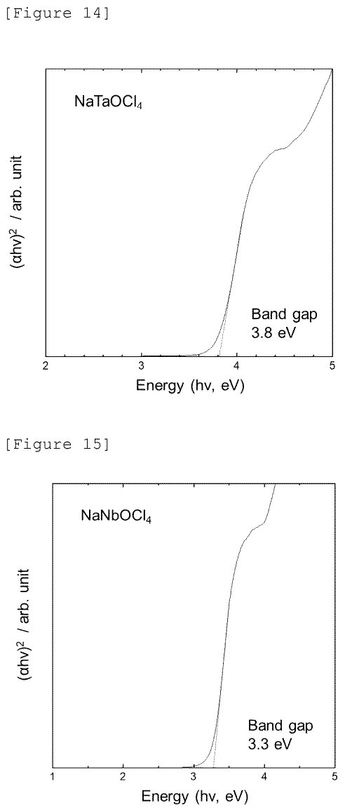

The band gap of NaNbCl₆ was 3.1 eV as illustrated in FIG. 12, the band gap of NaTaCl₆ was 3.7 eV as illustrated in FIG. 13, the band gap of NaTaOCl₄ was 3.8 eV as illustrated in FIG. 14, and the band gap of NaNbOCl₄ was 3.3 eV as illustrated in FIG. 15, all of which were higher than 3 eV. This result indicates that the electron conductivity of the solid electrolyte obtained in Examples is low (high electronic insulation).

### Example 101

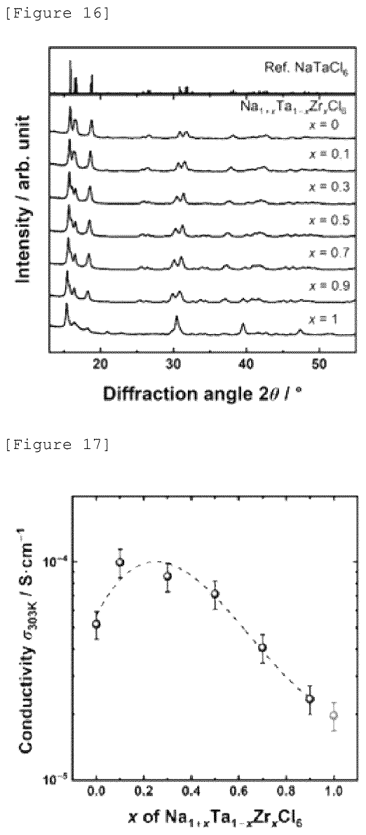

The influence of the carrier concentration in the solid electrolyte on ion conduction was studied by synthesizing Na₁₊ₓTa₁₋ₓZrₓCl₆ through element substitution with Zr. Na₁₊ₓTa₁₋ₓZrₓCl₆ was synthesized by a mechanochemical method using reagents of NaCl, TaCl₅, and ZrCl₄. Specifically, the powdery reagents weighed at a stoichiometric ratio were filled together with a Zr milling medium into an 80 mL planetary ball mill cup made of zirconia, and subjected to mechanochemical synthesis at 500 rpm for 33 hours using a planetary ball mill P-7 manufactured by Fritsch. At this time, 10 minutes of mechanical mixing was repeated 198 times every 10 minutes to prevent the inside of the ball mill from being excessively heated. The obtained powder was collected in a glove box, and its properties were studied by X-ray diffraction and impedance measurement (FIG. 16). Na₁₊ₓTa₁₋ₓZrₓCl₆ has a crystal structure similar to that of NaTaCl₆ in the range of x<1.0, indicating that the amount of Na in the crystal structure can be modulated. As illustrated in FIG. 17, it was found that higher ionic conductivity was exhibited when containing a small amount of Zr. This result indicates that the adjustment of the amount of Na affects the ionic conductivity, and suggests that the increase in the amount of Na ions increases the electrostatic repulsion between conductive ions, thereby improving the Na ion conduction.

### Test Example 1: Preparation of NaTa_{1/5(3+2x)}O_{X}Cl₄

NaTa_{1/5(3+2x)}O_{X}Cl₄ as shown in the following table was synthesized by a mechanochemical method using NaCl, TaCl₅, and Ta₂O₅ reagents. Specifically, the powdery reagents weighed at a stoichiometric ratio were filled together with a Zr milling medium into an 80 mL planetary ball mill cup made of zirconia, and subjected to mechanochemical synthesis at 600 rpm for 100 hours using a planetary ball mill P-7 manufactured by Fritsch. At this time, 10 minutes of mechanical mixing was repeated 600 times every 10 minutes to prevent the inside of the ball mill from being excessively heated. The obtained powder was collected in a glove box, and its properties were studied by X-ray diffraction and impedance measurement.

TABLE 1

| | | | | | Conductivity | Activation |
|---|---|---|---|---|---|---|
| | | | | | at RT | energy |
| | NaCl | TaCl₅ | Ta₂O₅ | x | (mS/cm) | (eV) |
| NTa_{1/5(3+2x)}OₓCl₄ | 5 | 3 | 1 | 1 | 1.4 | 0.32 |
| | | | 0.8 | 0.8 | 1 | 0.31 |
| | | | 0.5 | 0.5 | 0.89 | 0.32 |
| | | | 0.3 | 0.3 | 0.48 | 0.32 |
| | | | 0 | 0 | 0.14 | 0.36 |

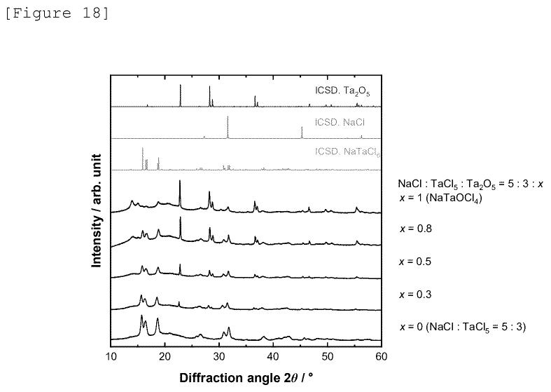

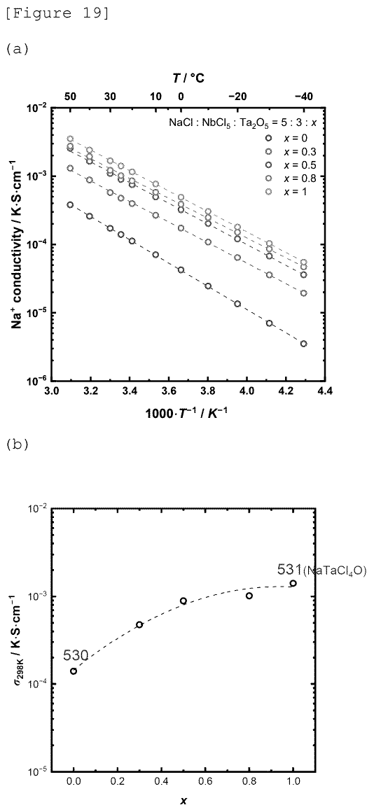

When Ta₂O₅ was used as the oxygen source, Ta₂O₅ remained, and the other phases were greatly amorphized (FIG. 18). A great improvement in the conductivity was confirmed by increasing the amount of introduced oxygen, although it is shown that not all of the introduced oxygen was used ((a) and (b) of FIG. 19).

### Test Example 2: Preparation of Na₁₊ₓTaOCl₄₊ₓ

Na₁₊ₓTaOCl₄₊ₓ as shown in the following table was synthesized by a mechanochemical method using NaCl, TaCl₅, and Ta₂O₅ reagents. Specifically, the powdery reagents weighed at a stoichiometric ratio were filled together with a Zr milling medium into an 80 mL planetary ball mill cup made of zirconia, and subjected to mechanochemical synthesis at 600 rpm for 100 hours using a planetary ball mill P-7 manufactured by Fritsch. At this time, 10 minutes of mechanical mixing was repeated 600 times every 10 minutes to prevent the inside of the ball mill from being excessively heated. The obtained powder was collected in a glove box, and its properties were studied by X-ray diffraction and impedance measurement.

TABLE 2

| | | | | | Conductivity | Activation |
|---|---|---|---|---|---|---|
| | | | | | at RT | energy |
| | NaCl | TaCl₅ | Ta₂O₅ | x | (mS/cm) | (eV) |
| Na₁₊ₓTaOCl₄₊ₓ | 5 | 3 | 1 | 0 | 1.4 | 0.32 |
| | 6 | | | 0.2 | 1.4 | 0.33 |
| | 7 | | | 0.4 | 1.5 | 0.34 |
| | 10 | | | 1 | 1.9 | 0.33 |
| | 14 | | | 1.8 | 1.7 | 0.34 |

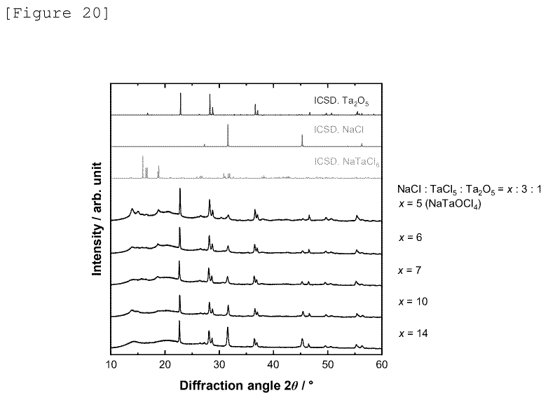

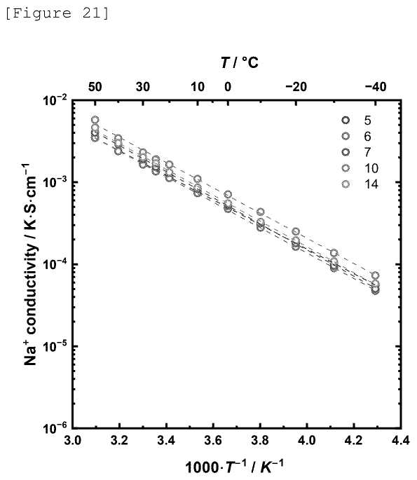

The influence of conductivity due to a change in the amount of NaCl was searched, and it was possible to synthesize a substance exceeding 1 mS/cm with almost no influence (FIGS. 20 and 21).

### Test Example 3: Preparation of NaTaOCl₄

Using NaCl, TaCl₅ and Ta₂O₅ reagents at a mass ratio of 5:3:1, they were synthesized by mechanochemical method. Specifically, the weighed powder reagent was filled into an 80 mL planetary ball mill cup made of zirconia together with a Zr milling medium, and mechanochemical synthesis was performed at 600 rpm for 25 hours, 50 hours, 75 hours, and 100 hours, respectively, using a planetary ball mill P-7 manufactured by Fritsch. At this time, in the mechanical mixing of the ball mill, the operation for 10 minutes was repeated 150, 300, 450, and 600 times every 10 minutes in order to prevent the inside from being excessively heated. The powder obtained at each synthesis time was collected in a glove box, and its properties were studied by X-ray diffraction and impedance measurement.

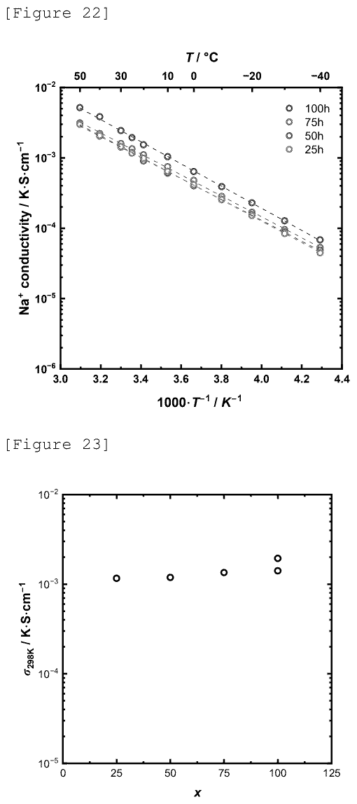

As a result, it was found that the conductivity was improved by the extension of the process time, but it was found that the conductivity which was not greatly changed was obtained even in a mill of a relatively short time of about 25 hours (FIGS. 22 and 23).

### Test Example 4: Preparation of Na₂ₓTaOₓCl₅

Na₂ₓTaOₓCl₅ as shown in the following table was synthesized by a mechanochemical method using Na₂O and TaCl₅ reagents. Specifically, the powdery reagents weighed at a stoichiometric ratio were filled together with a Zr milling medium into an 80 mL planetary ball mill cup made of zirconia, and subjected to mechanochemical synthesis at 600 rpm for 100 hours using a planetary ball mill P-7 manufactured by Fritsch. At this time, 10 minutes of mechanical mixing was repeated 600 times every 10 minutes to prevent the inside of the ball mill from being excessively heated. The obtained powder was collected in a glove box, and its properties were studied by X-ray diffraction and impedance measurement.

TABLE 3

| | | | | Conductivity | Activation |
|---|---|---|---|---|---|
| | Na₂O | TaCl₅ | x | at RT (mS/cm) | energy (eV) |
| Na₂ₓTaOₓCl₅ | 1.5 | 1 | 1.5 | 0.0062 | 0.41 |
| | 1 | | 1 | 0.5 | 0.33 |
| | 0.85 | | 0.85 | 2.6 | 0.32 |
| | 0.8 | | 0.8 | 3.7 | 0.33 |
| | 0.7 | | 0.7 | 2.9 | 0.33 |
| | 0.5 | | 0.5 | 1.5 | 0.34 |
| | 0.3 | | 0.3 | 0.98 | 0.34 |

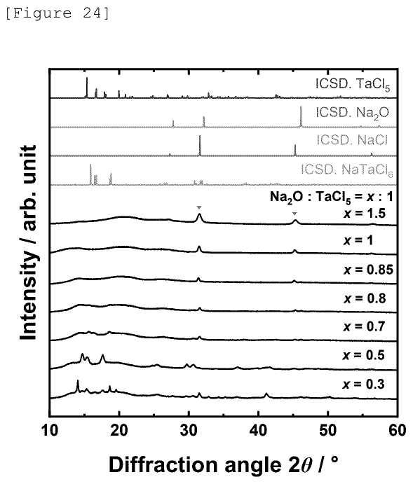

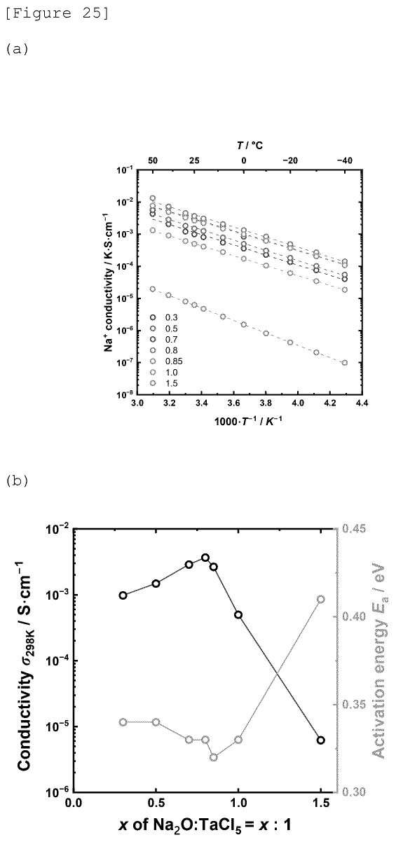

By changing the precursor reagent from Ta₂O₅ to Na₂O, glass that is more homogeneous was successfully synthesized. It is considered that the use of a soft substance having high reactivity as a precursor reagent and mechanical properties close to those of the other precursors is required for the synthesis of a homogeneous compound. Thereby, the reproducibility of high conductivity of 3.7 mS/cm was successfully improved (FIG. 24 and (a) and (b) of FIG. 25).

1. A solid electrolyte comprising a compound represented by Formula (1) or Formula (2): 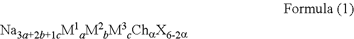
(in Formula (1), M¹ is selected from the group consisting of Y, Sc, Al, Ga, In, La, Ce, Pr, Nd, Pm, Sm, Eu, Gd, Tb, Dy, Ho, Er, Tm, Yb, Lu, and combinations thereof; M² is selected from the group consisting of Zr, Hf, Ti, Si, Ge, Sn, and combinations thereof; M³ is selected from the group consisting of Nb, Ta, V, P, Sb, Bi, and combinations thereof; Ch is selected from the group consisting of O, S, Se, Te, and combinations thereof; X is selected from the group consisting of F, Cl, Br, I, and combinations thereof; a+b+c=1, 0≤a≤1, 0≤b≤1, 0≤c≤1, and 0.1≤α≤2.9) 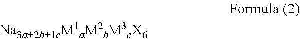
(in Formula (2), M¹ is selected from the group consisting of Y, Sc, Al, Ga, In, La, Ce, Pr, Nd, Pm, Sm, Eu, Gd, Tb, Dy, Ho, Er, Tm, Yb, Lu, and combinations thereof; M² is selected from the group consisting of Zr, Hf, Ti, Si, Ge, Sn, and combinations thereof; M³ is selected from the group consisting of Nb, Ta, V, P, Sb, Bi, and combinations thereof; X is selected from the group consisting of F, Cl, Br, I, and combinations thereof; and a+b+c=1, 0≤a≤0.9, 0≤b≤0.9, and 0.1≤c≤1).

2. The solid electrolyte according to claim 1, wherein
in Formula (2), M³ is selected from the group consisting of Ta and Nb.

3. The solid electrolyte according to claim 1, wherein
in Formula (1), X is Cl.

4. The solid electrolyte according to claim 1, wherein
in Formula (2), X is Cl.

5. The solid electrolyte according to claim 1, wherein
the solid electrolyte has a sodium ion conductivity of 1×10⁻⁶ S/cm or more at 25° C. when subjected to compression molding at room temperature under a pressure of 170 MPa.

6. The solid electrolyte according to claim 1, having a relative density of 80% or more when subjected to compression molding at room temperature under a pressure of 170 MPa.

7. A solid electrolyte comprising a compound represented by Formula (1′): 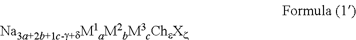
(in Formula (1′), M¹ is selected from the group consisting of Y, Sc, Al, Ga, In, La, Ce, Pr, Nd, Pm, Sm, Eu, Gd, Tb, Dy, Ho, Er, Tm, Yb, Lu, and combinations thereof, M² is selected from the group consisting of Zr, Hf, Ti, Si, Ge, Sn, and combinations thereof, M³ is selected from the group consisting of Nb, Ta, V, P, Sb, Bi, and combinations thereof, Ch is selected from the group consisting of O, S, Se, Te, and combinations thereof, X is selected from the group consisting of F, Cl, Br, I, and combinations thereof; a+b+c=1, 0≤a≤1, 0≤b≤1, 0≤c≤1, 0≤γ<≤1, 0≤δ≤2, 0≤ε≤2, and 4≤ζ≤8).

8. The solid electrolyte according to claim 7, wherein
in Formula (1′), X is Cl.

9. The solid electrolyte according to claim 7, wherein
the solid electrolyte has a sodium ion conductivity of 1×10⁻⁶ S/cm or more at 25° C. when subjected to compression molding at room temperature under a pressure of 170 MPa.

10. The solid electrolyte according to claim 7, having a relative density of 80% or more when subjected to compression molding at room temperature under a pressure of 170 MPa.

11. A solid electrolyte layer comprising the solid electrolyte according to claim 1.

12. A solid electrolyte battery comprising the solid electrolyte layer according to claim 11.
